(19) United States
(12) Patent Application Publication
(10) Pub. No.: US 2006/0086359 A1
(43) Pub. Date: Apr. 27, 2006

(54) Dual scale control knob for an oxygen conserving regulator

(75) Inventor: Gary Austin, Euclid, OH (US)

Correspondence Address: PEARNE & GORDON LLP, 1801 EAST 9TH STREET, SUITE 1200, CLEVELAND, OH, 44114-3108, US

(73) Assignee: TAGA MEDICAL TECHNOLOGIES, INC., Eastlake, OH (US)

(21) Appl. No.: 11/256,237

(22) Filed: Oct. 21, 2005

Related U.S. Application Data
(60) Provisional application No. 60/621,515, filed on Oct. 22, 2004.

(51) Int. Cl. A62B 7/04; A62B 7/00

(52) U.S. Cl. 128/204.26; 128/205.11

(57) ABSTRACT

An oxygen delivery device for delivering oxygen to a patient. A delivery mode selector is movable between first and second mode positions. A delivery rate selector is movable over a range and includes a first set of scale indicia having a first calibration and a second set of scale indicia having a second calibration being different from the first calibration. A method of operating the device includes selecting a first mode of operation of the device by setting the delivery mode selector to the first position and selecting a delivery rate by operating the delivery rate selector using the first set of scale indicia. The method also includes selecting a second mode of operation of the device by setting the delivery mode selector to the second position and selecting the delivery rate by operating the delivery rate selector using the second set of scale indicia.

### CROSS REFERENCE TO RELATED APPLICATION

This application claims priority of U.S. Provisional Patent Application No. 60/621,515 filed Oct. 22, 2004, which is incorporated herein by reference.

### BACKGROUND OF THE INVENTION

The present invention relates generally to medical oxygen delivery devices, and more particularly to a dual scale control knob for an oxygen conserving regulator.

Oxygen conserving devices are increasingly being used with portable oxygen supplies to allow a patient to extend the time between refilling of the tank. The goal of oxygen conserving devices is to maximize the duration that a portable oxygen supply tank will last while providing the necessary oxygen to maintain an appropriate 02 blood saturation level. Typical oxygen conserving devices include a device that senses inhalation by the patient and delivers oxygen only during the inhalation portion of the breathing cycle. Therefore, oxygen is not delivered during exhalation or stasis, and thus less oxygen is wasted.

Many such oxygen conserving devices include a selector that allows the patient to place the device in a continuous flow mode, temporarily eliminating the conserving function. Such oxygen conserving devices deliver oxygen at a certain flow rate, as set by a flow rate knob, regardless of the delivery mode. The flow rate stays the same whether delivering in a conserve mode which pulses with the breathing cycle or in a continuous mode which delivers a steady stream of oxygen regardless of the breathing cycle.

Some known oxygen conserving devices delivery a surplus of oxygen at the beginning of the breathing cycle, known as a “bolus,” and then taper off to the preset flow rate during the remainder of the inhalation portion or “tail.” The preset flow rate may be adequate when combined with the bolus at a prescribed setting. However, when delivered at a continuous flow rate, the preset flow rate may be too little. Therefore, if the flow rate of an oxygen conserving device is designed to be proper in the continuous mode then excess oxygen is delivered during the conserve mode thereby reducing the efficiency of the device. The patient may attempt to compensate by adjusting the flow rate knob, resulting in overdosing or under dosing of oxygen.

### BRIEF SUMMARY OF THE INVENTION

The present invention provides an oxygen delivery device comprising: an oxygen delivery portion for delivering a flow of oxygen for treatment of a patient; an oxygen delivery mode selector movable between a first mode position and a second mode position; and an oxygen delivery rate selector movable over a range and comprising a first set of scale indicia having a first calibration and a second set of scale indicia having a second calibration being different from the first calibration.

According to a further aspect, the present invention provides a selection knob for an oxygen delivery device having a first delivery mode and a second delivery mode. The selection knob comprises: a knob body; a first set of scale indicia provided on a peripheral surface of the knob body for indicating a rate of delivery of an oxygen delivery device operating in a first delivery mode, the first set of scale indicia having a first calibration; and a second set of scale indicia provided on the peripheral surface of the knob body for indicating a rate of delivery of an oxygen delivery device operating in a second delivery mode, the second set of scale indicia having a second calibration being different from the first calibration.

According to a still further aspect, the present invention provides a method of operating an oxygen delivery device comprising the steps of: selecting a first mode of operation of the oxygen delivery device by setting an oxygen delivery mode selector to a first position; selecting a delivery rate of the oxygen delivery device by operating a oxygen delivery rate selector according to a first set of scale indicia when the oxygen delivery device is operating in the first mode of operation; selecting a second mode of operation of the oxygen delivery device by setting the oxygen delivery mode selector to a second position; and selecting the delivery rate of the oxygen delivery device by operating the oxygen delivery rate selector according to a second set of scale indicia when the oxygen delivery device is operating in the second mode of operation.

### BRIEF SUMMARY OF THE DRAWINGS

FIG. 1 shows a control knob for an oxygen conserving regulator according to an example embodiment of the present invention.

### DETAILED DESCRIPTION OF THE INVENTION

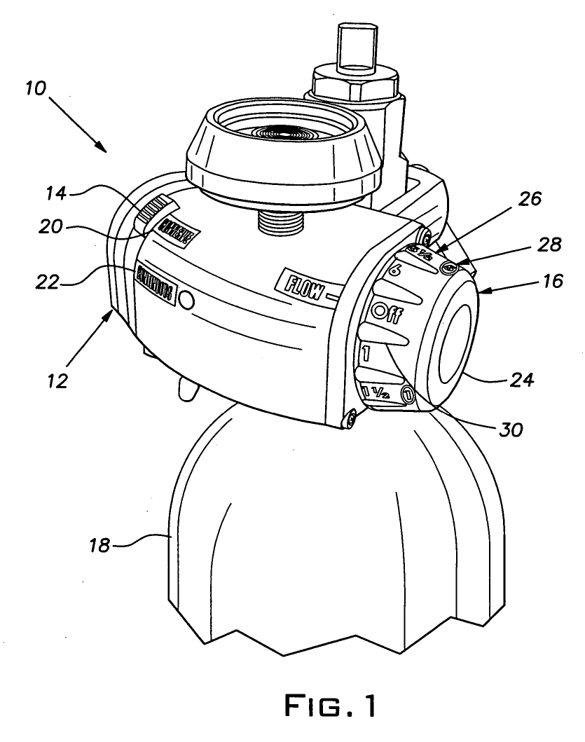

As shown in FIG. 1, according to an example embodiment of the present invention, an oxygen conserving device 10 comprises an oxygen delivery portion 12, an oxygen delivery mode selector 14, and an oxygen delivery rate selector 16. The oxygen delivery portion 12 is connectable to a pressurized oxygen supply 18 and oxygen cannula (not shown) for delivering a flow of oxygen for treatment of a patient (not shown).

The oxygen delivery mode selector 14 is movable between a first mode position 20 and a second mode position 22. Setting the oxygen delivery mode selector 14 to the first mode position 20 selects a oxygen conserving mode in which the oxygen delivery portion 12 delivers oxygen through the cannula in response to inhalation by the patient. Setting the oxygen delivery mode selector 14 to the second mode position 22 selects a continuous oxygen delivery mode of the oxygen delivery portion 12. In the example embodiment, the first mode position 20 is labeled in black to indicate oxygen conserving mode and the second mode position 22 is labeled in green to indicate the continuous oxygen flow mode.

The oxygen delivery rate selector 16 provides two different scales for the patient to utilize in setting a desired oxygen delivery or flow rate. According to the example embodiment, the oxygen delivery rate selector 16 comprises a rotatable selection control dial or knob 24 having a generally frustoconical knob body and a peripheral surface labeled with a first set of scale indicia 26 and a second set of scale indicia 28. The first and second sets of scale indicia 26,28 are in generally parallel alignment. The peripheral surface also includes a plurality of axially aligned grooves or knurls 30 arranged circumferentially around the knob body to assist the patient in gripping and turning the knob 24.

The selection knob 24 is movable over a range corresponding to the first and second sets of scale indicia 26, 28. The first set of scale indicia 26 is calibrated to the oxygen conserving mode in order to provide the proper delivery volume of oxygen when a bolus volume is added to a tail volume. The second set of scale indicia 28 is calibrated to the continuous oxygen delivery mode. Further, according to the present invention, coordinating markings are provided. Specifically, a circle is drawn around each of the second set of scale indicia 28, which corresponds to a circle drawn next to the word “CONTINUOUS” on the label for the second mode position of the oxygen delivery mode selector 14 to help remind the patient to read the second scale indicia 28 when continuous oxygen delivery mode is selected. Other symbols or corresponding markings may be used in place of the circles.

Alternatively, instead of using circles, the first and second scale indicia 26, 28 may be color-keyed to labels provided at the mode positions 20,22 for the oxygen delivery mode selector 14. For example embodiment, the numeral in the first set of scale indicia 26 may be colored black to correspond to the word “CONSERVE” printed in black on the oxygen conserving mode label provided at the first mode position 20 of the oxygen delivery mode selector 14. Likewise, the second set of scale indicia 28 may be colored green to correspond to the word “CONTINUOUS” printed in green on the continuous oxygen flow mode label provided at the second mode position 22. It should be appreciated that other colors or characteristics may be used in place of the black and green coordinating markings according to the present invention.

In operation, the patient selects either the oxygen conserving mode or the continuous oxygen flow mode using the oxygen delivery mode selector 14. The patient may then control the flow rate by rotating the selection knob 24 using the appropriate one of the two sets of scale indicia 26, 28 as a guide.

When the patient switches the oxygen conserving device 10 to the oxygen conserving mode, the oxygen delivery portion 12 delivers oxygen intermittently, in response to the patient's inhalation, at the selected flow rate. When the patient switches the oxygen conserving device 10 to the continuous mode, the oxygen delivery portion 12 delivers oxygen continuously at the selected flow rate. Having two different scales allows the conserving mode flow rate to be designed to work when combined with the bolus volume, independently of the requirements of the continuous mode. This allows for the optimization of the flow and conserving qualities of the oxygen conserving device 10.

It should be evident that this disclosure is by way of example and that various changes may be made by adding, modifying or eliminating details without departing from the fair scope of the teaching contained in this disclosure. The invention is therefore not limited to particular details of this disclosure.

What is claimed is:

1. An oxygen delivery device comprising:
an oxygen delivery portion for delivering a flow of oxygen for treatment of a patient;
an oxygen delivery mode selector movable between a first mode position and a second mode position; and
an oxygen delivery rate selector movable over a range and comprising a first set of scale indicia having a first calibration and a second set of scale indicia having a second calibration being different from the first calibration.

2. The oxygen delivery device of claim 1, wherein setting the oxygen delivery mode selector to the first mode position selects a oxygen conserving mode of the oxygen delivery portion and setting the oxygen delivery mode selector to the second mode position selects a continuous mode of the oxygen delivery portion.

3. The oxygen delivery device of claim 1, wherein the oxygen delivery rate selector further comprises a rotatable selection knob comprising the first set of scale indicia and the second set of scale indicia.

4. The oxygen delivery device of claim 3, wherein the rotatable selection knob further comprises a peripheral surface upon which the first set of scale indicia and the second set of scale indicia are provided.

5. The oxygen delivery device of claim 4, wherein the peripheral surface is generally frustoconical.

6. The oxygen delivery device of claim 1, wherein the first set of scale indicia are in generally parallel alignment with the second set of scale indicia.

7. The oxygen delivery device of claim 1, wherein the first set of scale indicia corresponds to a first range of delivery rates of the oxygen delivery portion when the oxygen delivery mode selector is set to the first mode position and the second set of scale indicia corresponds to a second range of delivery rates of the oxygen delivery portion when the oxygen delivery mode selector is set to the second mode position.

8. The oxygen delivery device of claim 1, wherein the first set of scale indicia is color-keyed to a first mode position label of the oxygen delivery mode selector and the second set of scale indicia is color-keyed to a second mode position label of the oxygen delivery mode selector.

9. The oxygen delivery device of claim 1, wherein the first set of scale indicia is provided with a coordinating marking and the first mode position of the oxygen delivery mode selector is provided with the coordinating marking, and wherein the second mode position of the oxygen delivery mode selector is not provided with the coordinating marking.

10. A selection knob for an oxygen delivery device having a first delivery mode and a second delivery mode, the selection knob comprising:
a knob body;
a first set of scale indicia provided on a peripheral surface of the knob body for indicating a rate of delivery of an oxygen delivery device operating in a first delivery mode, the first set of scale indicia having a first calibration; and
a second set of scale indicia provided on the peripheral surface of the knob body for indicating a rate of delivery of an oxygen delivery device operating in a second delivery mode, the second set of scale indicia having a second calibration being different from the first calibration.

11. The selection knob of claim 10, wherein the peripheral surface is generally frustoconical.

12. The selection knob of claim 10, wherein the first set of scale indicia are in generally parallel alignment with the second set of scale indicia.

13. The selection knob of claim 10, wherein the first set of scale indicia is color-keyed for corresponding to a first mode position label of the oxygen delivery mode selector and the second set of scale indicia is color-keyed for corresponding to a second mode position label of the oxygen delivery mode selector.

14. The oxygen delivery device of claim 10, wherein the first set of scale indicia is provided with a coordinating marking and the first mode position of the oxygen delivery mode selector is provided with the coordinating marking, and wherein the second mode position of the oxygen delivery mode selector is not provided with the coordinating marking.

15. A method of operating an oxygen delivery device comprising the steps of:
selecting a first mode of operation of the oxygen delivery device by setting an oxygen delivery mode selector to a first position;
selecting a delivery rate of the oxygen delivery device by operating a oxygen delivery rate selector according to a first set of scale indicia when the oxygen delivery device is operating in the first mode of operation;
selecting a second mode of operation of the oxygen delivery device by setting the oxygen delivery mode selector to a second position; and
selecting the delivery rate of the oxygen delivery device by operating the oxygen delivery rate selector according to a second set of scale indicia when the oxygen delivery device is operating in the second mode of operation.

16. The method of claim 15, wherein the first set of scale indicia has a first calibration and the second set of scale indicia has a second calibration being different from the first calibration.

17. The method of claim 15, wherein setting the oxygen delivery mode selector to the first position selects a oxygen conserving mode of the oxygen delivery device and setting the oxygen delivery mode selector to the second position selects a continuous mode of the oxygen delivery device.

18. The method of claim 15, wherein the oxygen delivery rate selector comprises a rotatable selection knob comprising the first set of scale indicia and the second set of scale indicia.

19. The method of claim 18, wherein the rotatable selection knob further comprises a peripheral surface upon which the first set of scale indicia and the second set of scale indicia are provided.

20. The method of claim 15, wherein the first set of scale indicia are in generally parallel alignment with the second set of scale indicia.

21. The method of claim 15, wherein the first set of scale indicia corresponds to a first range of delivery rates of the oxygen delivery device when the oxygen delivery mode selector is set to the first position and the second set of scale indicia corresponds to a second range of delivery rates of the oxygen delivery device when the oxygen delivery mode selector is set to the second position.

22. The method of claim 15, wherein the first set of scale indicia is color-keyed to a first position label of the oxygen delivery mode selector and the second set of scale indicia is color-keyed to a second position label of the oxygen delivery mode selector.

23. The oxygen delivery device of claim 15, wherein the first set of scale indicia is provided with a coordinating marking and the first position of the oxygen delivery mode selector is provided with the coordinating marking, and wherein the second position of the oxygen delivery mode selector is not provided with the coordinating marking.
